(19) United States
(12) Patent Application Publication
(10) Pub. No.: US 2026/0067308 A1
(43) Pub. Date: Mar. 5, 2026

(54) ASSISTING CYBERSECURITY INVESTIGATIONS USING LARGE LANGUAGE MODELS

(71) Applicant: Google LLC, Mountain View, CA (US)

(72) Inventors: Abu Wawda, Cupertino, CA (US); Shapor Naghibzadeh, San Francisco, CA (US); Spencer Daniel Lichtenstein, Greenville, SC (US)

(21) Appl. No.: 18/825,812

(22) Filed: Sep. 5, 2024

(51) Int. Cl. H04L 9/40

(52) U.S. Cl. CPC H04L 63/1425; H04L 63/1433

(57) ABSTRACT

A natural language (NL) prompt is received by a security analytics platform. The NL prompt is provided as input to a large language model (LLM). An output of the LLM is obtained. The output comprises an indication that an intent of the NL prompt is associated with a security investigation service of a plurality of security investigation services of the security analytics platform. The NL prompt is modified based on one or more parameters associated with the security investigation service. The modified NL prompt is provided as input to the security investigation service.

### TECHNICAL FIELD

Aspects and embodiments of the present disclosure relate to security analytics platforms, and in particular to assisting cybersecurity investigations using large language models.

### BACKGROUND

In today's digital age, organizations are constantly facing an increasing volume of sophisticated cybersecurity threats. Cybersecurity is the practice of protecting systems, networks, and data from digital attacks, unauthorized access, and damage. Traditional cybersecurity measures are often inadequate in providing comprehensive protection against such threats, which has resulted in the proliferation of large numbers of disparate cybersecurity operations tools such as Security Orchestration, Automation, and Response (SOAR) platforms, Security Information and Event Management (SIEM) systems, Intrusion Detection Systems (IDS), Intrusion Prevention Systems (IPS), antivirus software, endpoint protection, vulnerability management tools, and more. These platforms and systems can generate multiple alerts for each detection of a security threat. Because not all security threats are of equal importance, it can be challenging to sift through a large quantity of security threats. Analyzing and acting upon the staggering volume of security threats generated by such an ever-increasing number of cybersecurity operations tools is complex and cumbersome, leading to inefficiencies and vulnerabilities.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some embodiments, a system and method are disclosed for assisting cybersecurity investigations using large language models. In an embodiment, a method includes receiving, by a security analytics platform, a natural language (NL) prompt. The method further includes providing the NL prompt as input to a large language model (LLM). The method further includes obtaining an output of the LLM comprising an indication that an intent of the NL prompt is associated with a security investigation service of a plurality of security investigation services of the security analytics platform. The method further includes modifying the NL prompt based on one or more parameters associated with the security investigation service. The method further includes providing the modified NL prompt as input to the security investigation service.

In an embodiment, the modified NL prompt corresponds to a specified prompt format of the security investigation service. In an embodiment, the NL prompt is modified using the LLM, and the method further includes providing user log data as input to the LLM. The LLM is further configured to modify the NL prompt to include one or more characteristics of the user log data.

In an embodiment, the security investigation service is a Unified Data Model (UDM) search service. Providing the NL prompt as input to the security investigation service includes: providing the NL prompt to a second LLM configured to generate UDM search queries, obtaining an output of the second LLM comprising a UDM search query associated with the NL prompt, and providing the UDM search query as input to the UDM search service.

In an embodiment, the security investigation service is a security knowledge service. Providing the NL prompt as input to the security investigation service includes providing the NL prompt as input to a second LLM of the security knowledge service configured to answer security questions related to at least one of: security investigation techniques, types of security vulnerabilities, or known security threat entities.

In an embodiment, the method further includes receiving one or more outputs of the security investigation service. The method further includes providing the one or more outputs and one or more example summaries as input to a second LLM configured to summarize the one or more outputs based on the one or more example summaries. The method further includes obtaining an output of the second LLM comprising a summary of the one or more outputs. The method further includes providing the summary of the one or more outputs to be presented via the GUI of the security analytics platform.

In an embodiment, the method further includes, prior to receiving the NL prompt, providing one or more pre-defined NL prompts to be presented via the GUI of the security analytics platform.

In some embodiments a computer-readable storage medium (which can be non-transitory computer-readable storage medium, although the disclosure is not limited to that) stores instructions which, when executed, cause a processing device to perform operations comprising a method according to any embodiment or aspect described herein.

In some embodiments a system comprises: a memory; and a processing device operatively coupled with the memory to perform operations comprising a method according to any embodiment or aspect described herein.

### BRIEF DESCRIPTION OF DRAWINGS

Various embodiments in accordance with the present disclosure will be described with reference to the drawings, in which:

FIG. 1 is a block diagram of an example system architecture for a security analytics platform that assists cybersecurity investigations using large language models, in accordance with an embodiment;

FIG. 2 is a block diagram of an example security investigation service for security event search and rule generation, in accordance with an embodiment;

FIG. 3 is a block diagram of an example security investigation service for answering security questions, in accordance with an embodiment;

FIG. 4 is a sequence diagram of an example interaction between a client device, a security analytics platform service, an LLM inference service, and a security investigation service for assisting cybersecurity investigations using large language models, in accordance with an embodiment;

FIG. 5 is a flow diagram of an example method for assisting cybersecurity investigations using large language models, in accordance with an embodiment; and

FIG. 6 illustrates an example computer system, in accordance with at least one embodiment.

### DETAILED DESCRIPTION

Aspects and embodiments of the present disclosure relate to assisting cybersecurity investigations using large language models. A cybersecurity investigation can be a process conducted by a security practitioner to analyze computing resources for unexpected or undesired uses, events, configurations, or the like. A security practitioner can use various tools to inspect log data, configurations, and other inputs for anomalous activity and then determine causes and appropriate mitigations. Investigating cybersecurity-related events in a cloud platform can be a challenging task for an organization's security practitioners. Organizations are often under-resourced, and security practitioner expertise is in high demand. Security practitioners come from various backgrounds and may not have deep technical knowledge with specific toolsets or techniques. Furthermore, security practitioners frequently move between jobs, and often must learn new cybersecurity investigation toolsets. The cybersecurity market is flooded with many cybersecurity tools and products, each with different user experiences, which exacerbates the problem. Thus, security practitioners may face difficulty effectively using a new cloud security platform to find security events, analyze large volumes of security data, coordinate multiple supporting tools, and perform other necessary tasks. This can lead to consequences ranging from wasted or underutilized time and resources to missed security events resulting in security breaches, downtime, etc.

Aspects of the present disclosure address these and other challenges by providing a natural language interface for interacting with multiple security tools of a cloud security platform. Security practitioners can prompt the cloud security platform with a natural language query directed to one of multiple security investigation services provided by the security analytics platform. A security investigation service can be a tool dedicated to a specific type of security investigation technique, such as a security event search service or a general security question answering service. The security analytics platform can use a large language model (LLM) to determine an intent of the prompt and identify a security investigation service that is relevant to processing the prompt. The security analytics platform can then feed the prompt to the relevant security investigation service.

In an embodiment, the LLM can identify a search intent from the prompt and forward the prompt to a domain-specific language (DSL) search tool. In an embodiment, the security analytics platform can modify rewrite the prompt or generate a new prompt for feeding it to the relevant security service. For example, the security analytics platform can use the same LLM or a different LLM to translate the prompt into a DSL search query (e.g., UDM search query) or a rule in a formal rule definition language (e.g., YARA-L 2.0) before forwarding the prompt to a DSL search tool.

In an embodiment, the LLM can identify an open-ended security question in the prompt and forward the question to a second LLM trained to answer general security questions. The second LLM can use, e.g., publicly available data sources such as industry news and reports (e.g., via fine-tuning or retrieval augmented generation) to answer security questions.

In an embodiment, the security analytics platform can use the first LLM (or another LLM) to summarize results received from the relevant security investigation service and respond to follow-up prompts from the security practitioner. The security analytics platform can present pre-defined or suggested prompts to continue the investigation based on the previous results.

Accordingly, security analytics platforms and security practitioners using these techniques can more effectively use available security resources and time and reduce missed security events. Thus, systems monitored by security analytics platforms can experience fewer security breaches, reduced downtime, etc.

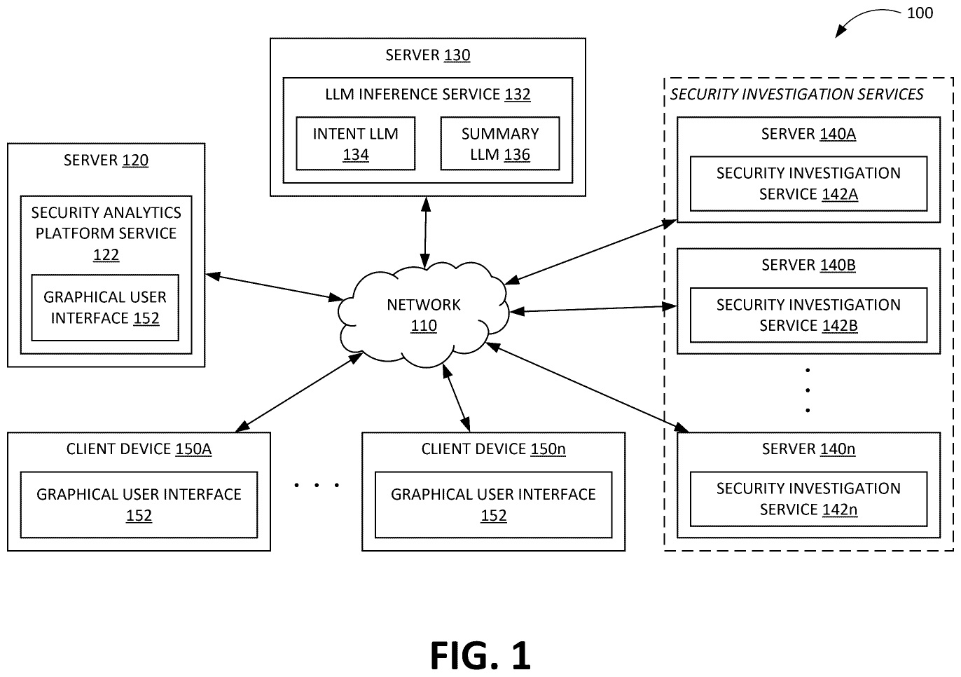

FIG. 1 is a block diagram of an example system architecture 100 for a security analytics platform that assists cybersecurity investigations using large language models, in accordance with an embodiment. System architecture 100 (also referred to as “system” or “media platform” herein) includes network 110, server devices 120-140n, and client devices 150A-n. In various embodiments, system 100 can include more or fewer components in different configurations than those depicted in FIG. 1. For example, system 100 can include additional servers, networks, etc.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households or communities, etc. In an embodiment, network 110 (or a component thereof) can be a physical or virtual interconnect within a single device, such as a PCIe bus, a messaging system, or an API.

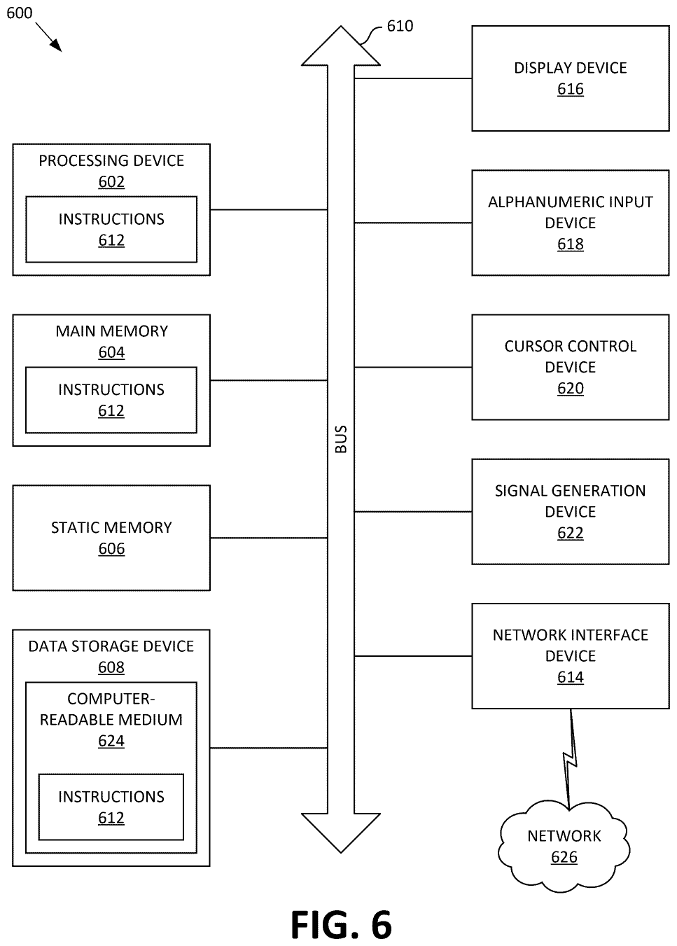

Each of servers 120-140n can be a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 can be an example of a server device. In various embodiments, each of servers 120-140n can be several computing devices, such as multiple rackmount servers in a data center(s) or multiple VMs in a cloud platform. In an embodiment, functions provided by servers 120-140n can alternatively be provided by a single server device.

Server 120 includes security analytics platform service 122. Security analytics platform service 122 can be a hardware (e.g., circuitry, dedicated logic, etc.) or software (e.g., code, libraries, firmware, etc.) tool that provides security analytics platform services to users (e.g., individuals or entities/organizations) or other services/applications. For example, security analytics platform service 122 can provide (e.g., send) a graphical user interface (e.g., GUI 152) to a client device. Security analytics platform service 122 can further receive user input such as natural language prompts, communicate with LLM inference service 132 to determine an intent of a natural language prompt, forward the prompt to one or more of security investigation services 142A-n, process the results of the security investigation service(s) (e.g., summarize security events retrieved by a search query), and present the results to the user via GUI 152. Security analytics platform service 122 can receive additional user input related to the displayed results and repeat any of the above or other actions as needed based on the user interaction. In an embodiment, security analytics platform service 122 can provide (e.g., via GUI 152) pre-defined example prompts or suggested prompts to help a user begin or continue a security investigation.

Server 130 includes large language model (LLM) inference service 132. LLM inference service 132 can be a hardware (e.g., ML accelerator) or software tool that runs inference operations on one or more LLMs based on input prompts and provides textual or other outputs responsive to the input prompts based on the LLM's training and configuration. LLM inference service 132 includes intent LLM 134 and summary LLM 136. Intent LLM 134 can be configured to identify an intent of a natural language prompt with respect to security investigation services 140A-n. Summary LLM 136 can be configured to summarize results of security investigation service. LLMs 134-136 can be configured with fine-tuning, prompt engineering, zero shot learning (e.g., providing a contextual description of a task), few shot learning (e.g., providing contextual examples of a task), or similar techniques. In an embodiment, intent LLM 134 and summary LLM 136 are the same LLM (e.g., LLM inference service 132 includes a single LLM).

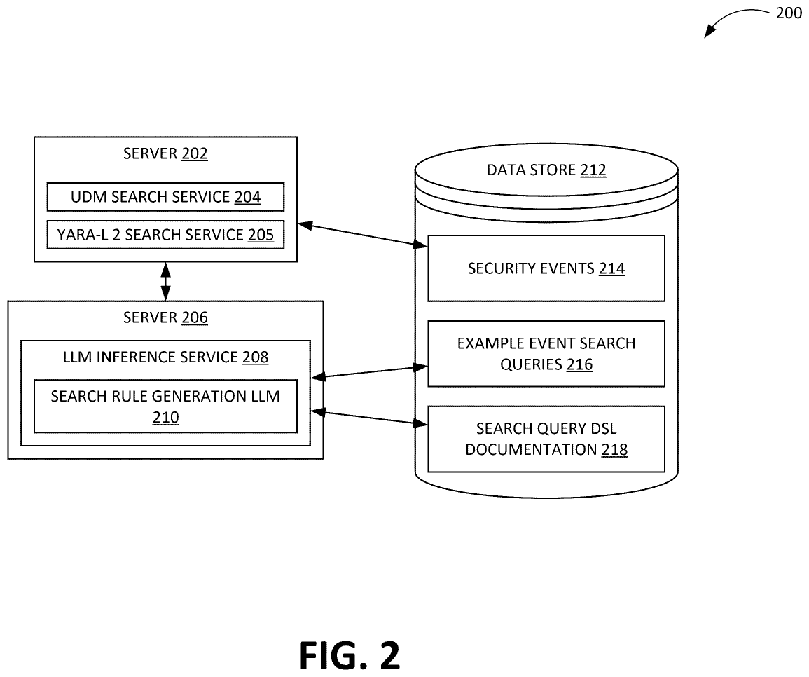

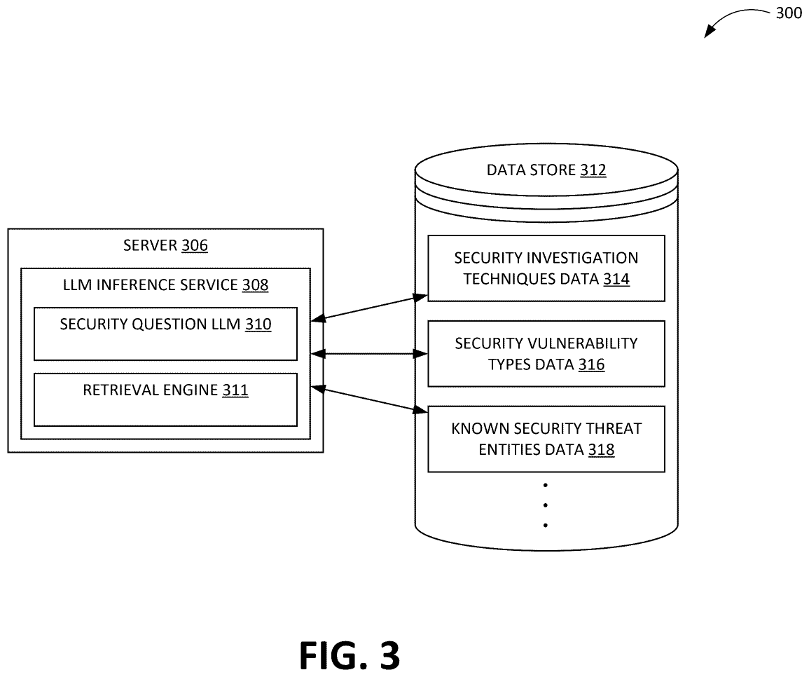

Servers 140A-n include security investigation services 142A-n. Security investigation services 142A-n can similarly be hardware or software tools that perform various investigation functions for system 100. Security investigation services 142A-n can receive unstructured or structured input, such as natural language prompts or queries conforming to a domain-specific language (DSL). Security investigation services 142A-n can similarly provide unstructured or structured output, such as natural language results or tabular search results. Various example security investigation services are further described with reference to FIGS. 2-3. In various embodiments, security investigation services can be included in a single server (e.g., multiple services in one server) or distributed across additional servers (e.g., multiple servers hosting one service).

Client devices 150A-n can be personal computers (PCs), laptops, notebook computers, mobile phones, smartphones, tablet computers, digital assistants, network-connected televisions (e.g., smart TVs), or any other computing devices. The computer system of FIG. 6 can be an example of a client device. In various embodiments, client devices 150A-n can also be referred to as “user devices.” Client devices 150A-n can run an operating system (OS) that manages hardware and software of the client devices. Client devices 150A-n can further include a web browser, application, or other software for displaying security analytics user interfaces and interacting with servers 120-140n. Client devices 150A-n can be used by users such as employees and customers of a security analytics platform. In general, and as described below, functions described in embodiments as being performed by a security analytics platform and/or server devices 120-140n can also or alternatively be performed on client devices 150A-n in other embodiments. In addition, the functionality attributed to a particular component can be performed by different or multiple components operating together.

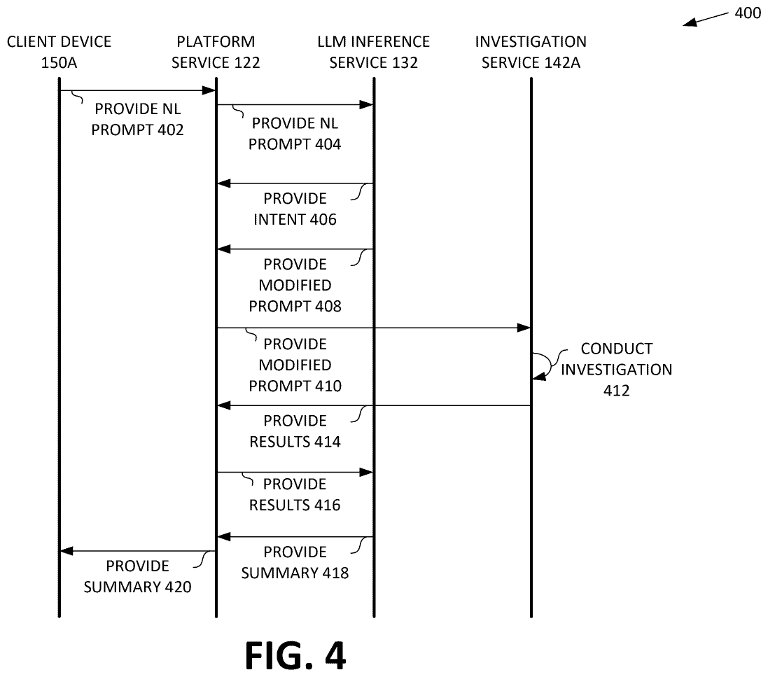

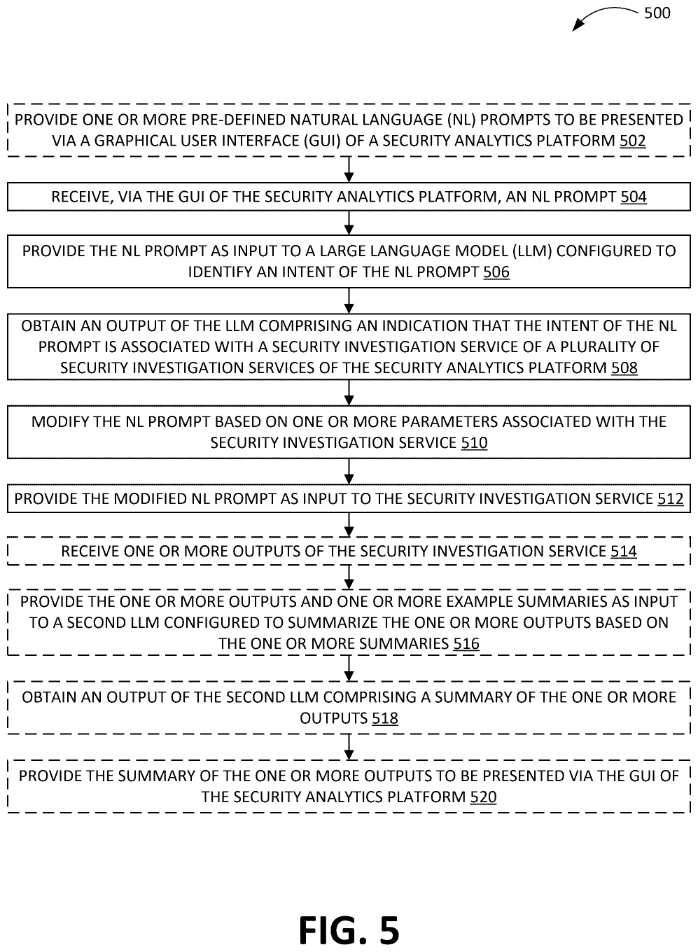

Client devices 150A-n include GUI 152 for receiving natural language prompts and other types of inputs from users and for providing security investigation results, summaries, and other types of outputs to users. GUI 152 can be received from security analytics platform service 122 (e.g., received as an interactive web application). Various user interactions with GUI 152 are further described with reference to FIGS. 4-5.

FIG. 2 is a block diagram of an example security investigation service 200 for security event search and rule generation, in accordance with an embodiment. Security investigation service 200 includes servers 202 and 206 and data store 212. In various embodiments, security investigation service 200 can include more or fewer components in different configurations than those depicted in FIG. 1. For example, the functions of servers 202 and 206 can be combined in a single server (e.g., as depicted for security investigation services 140A-n of FIG. 1).

Each of servers 202 and 206 can be a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 can be an example of a server device. In various embodiments, each of servers 202 and 206 can be several computing devices, such as multiple rackmount servers in a data center(s) or multiple VMs in a cloud platform.

Data store 212 is a persistent storage that is capable of storing data for security investigation service 200, such as security events 214, example event search queries 216, and search query domain-specific language documentation 218. Data store 212 can be hosted by one or more storage devices, such as main memory, magnetic or optical storage-based disks, tapes or hard drives, NAS, SAN, and so forth. In an embodiment, data store 212 is a network-attached file server. In various embodiments, data store 212 is some other type of persistent storage such as an object-oriented database, a relational database, and so forth. In an embodiment, data store 212 is hosted on or is a component of servers 202 and/or 206.

Server 202 includes example search services for UDM-based security event searching (UDM search service 204) and YARA-L 2.0-based security event searching (YARA-L 2 search service 205). Search services 204-205 can be hardware or software tools that can receive search queries in domain-specific languages (e.g., UDM queries or YARA-L 2.0 rules) and retrieve relevant search results from security events 214 of data store 212. UDM-based search queries can include data fields such as entities involved in an event, event type, when the event occurred, network metadata associated with the event, security classification of the event, or similar. UDM-based search queries can operate on saved event data such as logs. YARA-L 2.0 rules for event searching can include similar fields and can operate in real time on ingested event data.

Server 206 includes large language model (LLM) inference service 208. LLM inference service 208 can be a hardware (e.g., ML accelerator) or software tool that runs inference operations on one or more LLMs based on input prompts and returns textual or other outputs. LLM inference service 208 includes search rule generation LLM 210. Search rule generation LLM 210 can be configured to translate a natural language search query or a search query in one domain-specific language (e.g., a language with a level of abstraction suited for searching security events) to a search query in another domain-specific language. Such translations enable users to perform searches for relevant security events without being proficient in the domain-specific language(s). Search rule generation LLM 210 can be configured with fine-tuning (e.g., on search query domain-specific language documentation 218), prompt engineering, zero shot learning, few shot learning (e.g., on example event search queries 216), or similar techniques.

In an embodiment, LLM inference service 208 receives a natural language prompt that includes or can be interpreted as a security event search query (e.g., as determined by intent LLM 134). LLM inference service 208 retrieves search query translation examples from example event search queries 216. The search query translation examples can include pairs of example NL prompts and example search queries in a domain-specific language (e.g., UDM search queries), where the example DSL search queries are known to be valid translations of the example NL prompts. LLM inference service 208 uses the retrieved examples and the received natural language prompt to generate a prompt for search rule generation LLM 210 to generate multiple candidate DSL search queries. LLM inference service 208 receives candidate DSL search queries from LLM 210 and determines whether the candidate queries have valid syntax. If a syntactically valid query is found, the query can be forwarded to a DSL search service such as UDM search service 204 for processing. If no syntactically valid queries are found, LLM inference service 208 can try again or generate an error message.

In an embodiment, a user can request that a DSL search query (e.g., a UDM search query, possibly derived from a natural language query) be translated to a rule in a formal rule definition language (e.g., a YARA-L 2.0 rule). LLM inference service 208 receives a DSL search query. LLM inference service 208 retrieves relevant query-to-rule examples from example event search queries 216. LLM inference service 208 uses the retrieved examples and the received DSL query to generate a prompt for search rule generation LLM 210 to generate multiple candidate rules. LLM inference service 208 receives candidate rules from LLM 210 and determines whether the candidate rules have valid syntax. If a syntactically valid rule is found, the query can be forwarded to a search service such as YARA-L 2.0 search service 205 for processing or can be presented to the user.

FIG. 3 is a block diagram of an example security investigation service 300 for answering security questions, in accordance with an embodiment. Security investigation service 300 includes server 306 and data store 312. In various embodiments, security investigation service 300 can include more or fewer components in different configurations than those depicted in FIG. 1.

Server 306 can be a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 can be an example of a server device. In various embodiments, server 306 can be several computing devices, such as multiple rackmount servers in a data center(s) or multiple VMs in a cloud platform.

Data store 312 is a persistent storage that is capable of storing data for security investigation service 300, such as security investigation techniques data 314, security vulnerability types data 316, and known security threat entities data 318. Data store 312 can be hosted by one or more storage devices, such as main memory, magnetic or optical storage-based disks, tapes or hard drives, NAS, SAN, and so forth. In an embodiment, data store 312 is a network-attached file server. In various embodiments, data store 312 is some other type of persistent storage such as an object-oriented database, a relational database, and so forth. In an embodiment, data store 312 is hosted on or is a component of server 306.

Server 306 includes large language model (LLM) inference service 308. LLM inference service 308 can be a hardware (e.g., ML accelerator) or software tool that runs inference operations on one or more LLMs based on input prompts and returns textual or other outputs. LLM inference service 308 includes security question LLM 310 and retrieval engine 311. Security question LLM 310 can be configured to answer general security questions on various topics such as security investigation techniques, types of security vulnerabilities, known threat actors, or similar. Security question LLM 310 can be configured with fine-tuning, prompt engineering, zero shot learning, few shot learning, or similar techniques. Retrieval engine 311 can retrieve up-to-date security knowledge from data store 312 (e.g., from security investigation techniques data 314, security vulnerability types data 316, and known security threat entities data 318). LLM inference service 308 can use retrieval engine 311 to provide additional prompt context for security question LLM 310 using techniques such retrieval augmented generation (RAG) or similar.

In an embodiment, LLM inference engine 308 can identify threat actors or malware in a response to a security question. For example, LLM inference engine 308 can identify threat actor IDs or malware IDs in a response generated by security question LLM 310. LLM inference service can use retrieval engine 311 to cross reference the IDs with sources in data store 312.

FIG. 4 is a sequence diagram of an example interaction 400 between client device 150A, security analytics platform service 122, LLM inference service 132, and security investigation service 142A for assisting cybersecurity investigations using large language models, in accordance with an embodiment. In some embodiments, operations depicted in FIG. 4 could occur in a different order or be performed by different components than depicted. Various embodiments can include additional operations or components not depicted in FIG. 4 or a subset of operations or components depicted in FIG. 4. The operations depicted in FIG. 4 can correspond to different communication sessions or different timing intervals. For example, some operations can proceed in immediate succession or can be part of a single communication session, while other operations can be spread out over time or can be part of different communication sessions.

At operation 402, client device 150A provides (e.g., sends) an NL prompt to security analytics platform service 122. The NL prompt can be a freeform prompt of a user that is directed to at least security investigation service 142A. In various embodiments, the NL prompt can be directed to one or more additional security investigation services.

At operation 404, security analytics platform service 122 provides the NL prompt to LLM inference service 132 for intent determination. LLM inference service 132 can determine an intended security investigation service associated with the prompt using an LLM that has been configured to identify intent with techniques such as fine-tuning, prompt engineering, zero shot learning, few shot learning, etc. At operation 406, LLM inference service 132 provides the identified intent to security analytics platform service 122. LLM inference service 132 can further modify the NL prompt using an LLM that has been configured to modify the prompt based on characteristics of the intended security investigation service (e.g., an expected input format). At operation 408, LLM inference service 132 provides the modified prompt to security analytics platform service 122.

At operation 410, security analytics platform service 122 provides the modified (or unmodified) NL prompt to the identified security investigation service 142A. At operation 412, security investigation service 142A conducts a security investigation or performs other security-related tasks corresponding to security investigation service 142A's capabilities and the intent of the NL prompt. Security investigation service 142A can communicate with client device 150A, security analytics platform service 122, LLM inference service 132, and/or other entities as part of the investigation in various embodiments. At operation 414, security investigation service 142A feeds results of the security investigation to security analytics platform service 122.

At operation 416, security analytics platform service 122 feeds the results to LLM inference service 132 for summarization. LLM inference service 132 can summarize the results of the security investigation using an LLM that has been configured to summarize text, identify patterns in security event data, and similar. At operation 418, LLM inference service 132 feeds the summary to security analytics platform service 122. At operation 420, security analytics platform service 122 provides the summary to client device 150A. Interaction 400 can be repeated, with the provided summary being used as context for the next NL prompt and/or to suggest follow-on prompts for the user to select.

FIG. 5 is a flow diagram of an example method 500 for assisting cybersecurity investigations using large language models, in accordance with an embodiment. Method 500 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 500. Method 500 can also be associated with a set of instructions stored on a non-transitory computer-readable medium (e.g., magnetic or optical disk, etc.). The instructions, when executed by a processing device, can cause the processing device to perform operations comprising the blocks of method 500. In at least one embodiment, method 500 is performed by one or more of servers 120-140n or client devices 150A-n of FIG. 1, or components thereof. In at least one embodiment, method 500 is performed by computing system 600 of FIG. 6. In some embodiments, blocks depicted in FIG. 5 could be performed simultaneously or in a different order than depicted. Various embodiments can include additional blocks not depicted in FIG. 5 or a subset of blocks depicted in FIG. 5. For example, blocks depicted with a dashed outline (e.g., blocks 502 and 514-520) can be absent in an embodiment.

At block 502, processing logic provides one or more pre-defined natural language (NL) prompts to be presented via a graphical user interface (GUI) of a security analytics platform. For example, the NL prompts can be example prompts or suggested starter prompts to help a user begin a security investigation. In another example, the pre-defined NL prompts can be dynamically generated based on results of a security investigation service (e.g., from a previous round of prompting and investigation). In an embodiment, the GUI is GUI 152 of FIG. 1.

At block 504, the processing logic receives, by the security analytics platform (e.g., via the GUI), an NL prompt. The NL prompt can be a freeform prompt (e.g., input by user) that is directed to at least one security investigation service of a set security investigation services. For example, the user can name the service specifically (e.g., “perform the following UDM event search . . . ”). In another example, the user may not know the desired security investigation service, but the prompt and context can be associated with a specific investigation service (e.g., help me find security events relating to . . . ”).

At block 506, the processing logic provides the NL prompt as input to a large language model (LLM), which can be configured (e.g., fine-tuned, prompted) to identify an intent of the NL prompt. The LLM can be intent LLM 134 of FIG. 1, for example. In an embodiment, the processing logic can further provide user log data as input to the LLM, and the LLM can be further configured to modify the NL prompt to include one or more characteristics of the user log data.

At block 508, the processing logic obtains an output of the LLM comprising an indication that an intent of the NL prompt is associated with a security investigation service of a plurality of security investigation services of the security analytics platform. The plurality of security investigation services can be security investigation services 142A-n, for example. The output of the LLM can be a generative output, such as text to be forwarded to the security investigation service, or the output can be a discriminative output, such as a classification of the associated security investigation service.

At block 510, the processing logic modifies the NL prompt based on one or more parameters associated with the security investigation service. For example, the processing logic can modify the NL prompt by rewriting it or generating a replacement prompt using an LLM that has been trained or configured to output modified prompts based on the one or more parameters, as described with reference to FIG. 1. In another example, the processing logic can use a set of pre-determined algorithms for prompt substitution such as regular expressions, if/else logic, or similar. The parameters associated with the security investigation service can be a specified input format such as a domain-specific language, a function signature, or similar, and the modified NL prompt can correspond to the specified input format of the security investigation service. In an embodiment, the NL prompt is modified using the LLM of blocks 506-508. For example, the LLM of blocks 506 can be trained or configured to simultaneously or sequentially identify an intent and modify the prompt to correspond to the security investigation service associated with the intent. The outputs of the LLM can thus include the identified intent/service and the modified prompt.

At block 512, the processing logic provides the modified NL prompt as input to the security investigation service. In an embodiment, the security investigation service is a Unified Data Model (UDM) search service. Providing the NL prompt as input to the UDM search service can include providing the NL prompt to a second LLM configured to generate UDM search queries, obtaining an output of the second LLM comprising a UDM search query associated with the NL prompt, and providing the UDM search query as input to the UDM search service. In an embodiment, the second LLM can be the same LLM as the LLM of blocks 506-508.

In an embodiment, the security investigation service is a security knowledge service. Providing the NL prompt as input to the security knowledge service includes providing the NL prompt as input to a second LLM of the security knowledge service configured to answer security questions related to at least one of: security investigation techniques (e.g., event search and analysis), types of security vulnerabilities (e.g., rowhammer), or known security threat entities (e.g., APTs). The LLM can include a retrieval augmented generation (RAG) engine that can draw from security knowledge resources such as industry news and reports. In an embodiment, the second LLM can be the same LLM as the LLM of blocks 506-508.

At block 514, the processing logic receives one or more outputs of the security investigation service. The output(s) an include structured or unstructured data, such as natural language, tabular search results, etc.

At block 516, the processing logic provides the one or more outputs and one or more example summaries as input to a second LLM configured to summarize the one or more outputs based on the one or more example summaries. The second LLM can be summary LLM 136 of FIG. 1, for example. Summarizing the output(s) can involve shortening natural language outputs, identifying a subset of relevant search results, identifying patterns and trends in search results, or similar. In an embodiment, the second LLM can be the same LLM as the LLM of blocks 506-508.

At block 518, the processing logic obtains an output of the second LLM comprising a summary of the one or more outputs. At block 520, the processing logic provides the summary of the one or more outputs to be presented via the GUI of the security analytics platform. In an embodiment, method 500 can begin again as the user continues to refine their security investigation.

FIG. 6 is a block diagram illustrating an example computer system 600, in accordance with embodiments of the present disclosure. Computer system 600 can correspond to server machines 110-140 or client devices 150A-n, as described with reference to FIG. 1. Computer system 600 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 600 includes processing device 602 (e.g., one or more processors or cores), main memory 604 (e.g., read-only memory (ROM), flash memory, dynamic random access memory (DRAM) such as synchronous DRAM (SDRAM), double data rate (DDR SDRAM), or DRAM (RDRAM), etc.), static memory 606 (e.g., flash memory, static random access memory (SRAM), etc.), and data storage device 608, which communicate with each other via bus 610.

Processing device 602 represents one or more general-purpose processing devices such as a microprocessor, central processing unit, or the like. More particularly, processing device 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. Processing device 602 is configured to execute instructions 612 (e.g., for generating customized lyric captions using machine learning models) for performing the operations discussed herein.

Computer system 600 can further include network interface device 614. Computer system 600 also can include display device 616 (e.g., a liquid crystal display (LCD) or a cathode ray tube (CRT)), alphanumeric input device 618 (e.g., a keyboard, and alphanumeric keyboard, a motion sensing input device, touch screen), cursor control device 620 (e.g., a mouse), and signal generation device 622 (e.g., a speaker). In some embodiments, computer system 600 may not include display device 616, alphanumeric input device 618, and/or cursor control device 620 (e.g., in a headless configuration).

Data storage device 608 can include a non-transitory machine-readable storage medium 624 (also computer-readable storage medium) on which is stored one or more sets of instructions 612 (e.g., for generating customized lyric captions using machine learning models) embodying any one or more of the methodologies or functions described herein. Instructions 612 can also reside, completely or at least partially, within main memory 604 or within the processing device 602 during execution thereof by computer system 600, main memory 604 and processing device 602 also constituting machine-readable storage media. Instructions 612 can further be transmitted or received over network 626 via network interface device 614.

In one implementation, instructions 612 include instructions for generating customized lyric captions using machine learning models, as described herein. While computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, by a security analytics platform, a natural language (NL) prompt;
providing the NL prompt as input to a large language model (LLM);
obtaining an output of the LLM comprising an indication that an intent of the NL prompt is associated with a security investigation service of a plurality of security investigation services of the security analytics platform;
modifying the NL prompt based on one or more parameters associated with the security investigation service; and
providing the modified NL prompt as input to the security investigation service.

2. The method of claim 1, wherein the modified NL prompt corresponds to a specified prompt format of the security investigation service.

3. The method of claim 2, wherein the NL prompt is modified using the LLM, and wherein the method further comprises:
providing user log data as input to the LLM, wherein the LLM is further configured to modify the NL prompt to include one or more characteristics of the user log data.

4. The method of claim 1, wherein the security investigation service is a security event search service, and wherein providing the NL prompt as input to the security investigation service comprises:
providing the NL prompt to a second LLM configured to generate security event search queries;
obtaining an output of the second LLM comprising a security event search query associated with the NL prompt; and
providing the security event search query as input to the security event search service.

5. The method of claim 1, wherein the security investigation service is a security knowledge service, and wherein providing the NL prompt as input to the security investigation service comprises:
providing the NL prompt as input to a second LLM of the security knowledge service configured to answer security questions related to at least one of: security investigation techniques, types of security vulnerabilities, or known security threat entities.

6. The method of claim 1, further comprising:
receiving one or more outputs of the security investigation service;
providing the one or more outputs and one or more example summaries as input to a second LLM configured to summarize the one or more outputs based on the one or more example summaries;
obtaining an output of the second LLM comprising a summary of the one or more outputs; and
providing the summary of the one or more outputs to be presented via the GUI of the security analytics platform.

7. The method of claim 1, further comprising:
prior to receiving the NL prompt, providing one or more pre-defined NL prompts to be presented via the GUI of the security analytics platform.

8. A system comprising:
a memory device; and
a processing device coupled to the memory device, the processing device to perform operations comprising:
receiving, by a security analytics platform, a natural language (NL) prompt;
providing the NL prompt as input to a large language model (LLM);
obtaining an output of the LLM comprising an indication that an intent of the NL prompt is associated with a security investigation service of a plurality of security investigation services of the security analytics platform;
modifying the NL prompt based on one or more parameters associated with the security investigation service; and
providing the modified NL prompt as input to the security investigation service.

9. The system of claim 8, wherein the modified NL prompt corresponds to a specified prompt format of the security investigation service.

10. The system of claim 9, wherein the NL prompt is modified using the LLM, and wherein the operations further comprise:
providing user log data as input to the LLM, wherein the LLM is further configured to modify the NL prompt to include one or more characteristics of the user log data.

11. The system of claim 8, wherein the security investigation service is a security event search service, and wherein providing the NL prompt as input to the security investigation service comprises:
providing the NL prompt to a second LLM configured to generate security event search queries;
obtaining an output of the second LLM comprising a security event search query associated with the NL prompt; and
providing the security event search query as input to the security event search service.

12. The system of claim 8, wherein the security investigation service is a security knowledge service, and wherein providing the NL prompt as input to the security investigation service comprises:
providing the NL prompt as input to a second LLM of the security knowledge service configured to answer security questions related to at least one of: security investigation techniques, types of security vulnerabilities, or known security threat entities.

13. The system of claim 8, the operations further comprising:
receiving one or more outputs of the security investigation service;
providing the one or more outputs and one or more example summaries as input to a second LLM configured to summarize the one or more outputs based on the one or more example summaries;
obtaining an output of the second LLM comprising a summary of the one or more outputs; and
providing the summary of the one or more outputs to be presented via the GUI of the security analytics platform.

14. The system of claim 8, the operations further comprising:
prior to receiving the NL prompt, providing one or more pre-defined NL prompts to be presented via the GUI of the security analytics platform.

15. A non-transitory computer-readable medium comprising instructions that, when executed by a processing device, cause the processing device to perform operations comprising:
receiving, by a security analytics platform, a natural language (NL) prompt;
providing the NL prompt as input to a large language model (LLM);
obtaining an output of the LLM comprising an indication that an intent of the NL prompt is associated with a security investigation service of a plurality of security investigation services of the security analytics platform;
modifying the NL prompt based on one or more parameters associated with the security investigation service; and
providing the modified NL prompt as input to the security investigation service.

16. The non-transitory computer-readable medium of claim 15, wherein the modified NL prompt corresponds to a specified prompt format of the security investigation service.

17. The non-transitory computer-readable medium of claim 16, wherein the NL prompt is modified using the LLM, and wherein the operations further comprise:
providing user log data as input to the LLM, wherein the LLM is further configured to modify the NL prompt to include one or more characteristics of the user log data.

18. The non-transitory computer-readable medium of claim 15, wherein the security investigation service is a security event search service, and wherein providing the NL prompt as input to the security investigation service comprises:
providing the NL prompt to a second LLM configured to generate security event search queries;
obtaining an output of the second LLM comprising a security event search query associated with the NL prompt; and
providing the security event search query as input to the security event search service.

19. The non-transitory computer-readable medium of claim 15, wherein the security investigation service is a security knowledge service, and wherein providing the NL prompt as input to the security investigation service comprises:
providing the NL prompt as input to a second LLM of the security knowledge service configured to answer security questions related to at least one of: security investigation techniques, types of security vulnerabilities, or known security threat entities.

20. The non-transitory computer-readable medium of claim 15, the operations further comprising:
receiving one or more outputs of the security investigation service;
providing the one or more outputs and one or more example summaries as input to a second LLM configured to summarize the one or more outputs based on the one or more example summaries;
obtaining an output of the second LLM comprising a summary of the one or more outputs; and
providing the summary of the one or more outputs to be presented via the GUI of the security analytics platform.
